(19) United States
(12) Patent Application Publication
(10) Pub. No.: US 2007/0277205 A1
(43) Pub. Date: Nov. 29, 2007

(54) System and method for distributing video data

(75) Inventor: Michael F. Grannan, Austin, TX (US)

Correspondence Address: G. Michael Roebuck, PC, FROST BANK BUILDING, 6750 WEST LOOP SOUTH, SUITE 920, BELLAIRE, TX, 77401, US

(73) Assignee: SBC Knowledge Ventures L.P., Reno, NV (US)

(21) Appl. No.: 11/442,083

(22) Filed: May 26, 2006

(51) Int. Cl. H04N 7/18; H04N 7/173

(52) U.S. Cl. 725/80; 725/133; 725/134; 725/86; 725/78

(57) ABSTRACT

In a first embodiment a method for distributing video data from an originating device in a communication network is disclosed including storing metadata at the originating device describing the video data; selecting at the originating device, a plurality of candidate devices to receive the video data based on a correlation between the metadata and subscriber profiles for the plurality of candidate devices; and distributing the video data to a first set selected from the plurality of candidate devices in the communication network based on the correlation. In a second embodiment a system for distributing video data from an originating device in a communication network is disclosed including a server having a processor in communication with a memory; and a computer program stored in the memory, the computer program including instructions to store metadata received from originating device describing the video data, instructions to select at the server, a plurality of candidate devices to receive video data based on a correlation between the metadata and subscriber profiles for the plurality of candidate devices; and instructions to distribute the video data to a first set of candidate devices selected from the plurality of candidate devices in the communication network based on the correlation.

### FIELD OF THE DISCLOSURE

The present disclosure relates generally to video data distribution.

### BACKGROUND

The paradigm of television programming is rapidly changing due to new video distribution and consumption models being fostered by the Internet. In the traditional broadcast programming environment, more and more content is being viewed “on demand” as additional new subscribers purchase and view pay-per-view (PPV) and on demand content. Many subscribers now have digital video recorders (DVRs) to enable them to watch broadcast video content when they want to instead of when the broadcaster wants them to.

In addition, the Internet is quickly becoming another delivery mechanism for video content. Companies have struck deals with major networks to distribute prime time programming to video units via the Internet. Video service are now available providing access to episodes including major broadcast network television shows for viewing from a personal computer.

### BRIEF DESCRIPTION OF THE DRAWINGS

FIG. 1 is a schematic diagram of an illustrative embodiment showing an IPTV system for delivering video content;

FIG. 2 depicts a flowchart of functions performed in an illustrative embodiment for inputting user authored video content and making it available to other television service subscribers in the IPTV system;

FIG. 3 is a schematic diagram of peer groups for video data distribution in an IPTV system;

FIG. 4 depicts a flow chart of functions performed in distributing video content from an IPTV system having groups of nodes;

FIG. 5 depicts a flow chart of functions performed in an illustrative embodiment in providing a live broadcast of user authored video content from a node;

FIG. 6 depicts a flow chart of functions performed in an illustrative embodiment in providing aggregate user authored video data programs and advertising in a IPTV system; and

FIG. 7 is a diagrammatic representation of a machine in the form of a computer system within which a set of instructions, when executed, may cause the machine to perform any one or more of the methodologies of the illustrative embodiment.

### DETAILED DESCRIPTION

In view of the above, an illustrative embodiment is presented through one or more of its various aspects to provide one or more advantages, such as those noted below.

In a particular embodiment a method for distributing video data from an originating device in a communication network is disclosed. In a particular embodiment the method includes storing metadata at the originating device describing the video data, selecting at the originating device, a plurality of candidate devices to receive the video data based on a correlation between the metadata and subscriber profiles for the plurality of candidate devices, and distributing the video data to a first set selected from the plurality of candidate devices in the communication network based on the correlation.

In another particular embodiment the originating device, the plurality of candidate devices and a server are members of a peer to peer network in an internet protocol television (IPTV) network and wherein the video data is made available to members of the peer to peer network for distribution over the peer to peer network. In another particular embodiment the method further includes wherein the originating device sends video data to the server for distributing the video data to subscribers via the IPTV network.

In another particular embodiment distributing the video data further includes sending the video data in near real time from the originating device through a server to the first set of candidate devices. In a particular embodiment, the server can be any node in an IPTV network.

In another particular embodiment the method further includes searching metadata at the originating device for video data files to select desired video data files from the video data files having desired attributes based on a set of recommendation criteria, aggregating video data files having the desired attributes into a video program at the originating client device, and sending the program from the originating device to another member of the peer to peer network.

In another particular embodiment the method further includes determining an advertising category for the program based on a correlation between the metadata and an advertising category, and inserting an advertisement from the advertising category into the program. In another particular embodiment the method further includes placing a listing for the video data in an electronic program guide based on a set of recommendation criteria. In the illustrative embodiment a listing for a video data includes but is not limited to metadata describing the video data. In another particular embodiment the method further includes recommending to a second set selected from the candidate devices video data video programs based on the set of recommendation criteria.

In another particular embodiment the recommendation criteria is selected from the group consisting of popularity, number of viewings, number of ratings, percent of viewings rating, percent of rating favorable, percent of ratings unfavorable, demographics for favorable ratings and demographics for unfavorable ratings.

In another particular embodiment the method further includes correlating recommendation criteria with an advertising type and placing an advertisement in the video program based on the correlation. In another particular embodiment the method further includes applying processing to the program selected from the group consisting of applying digital rights management, applying approved video formatting and setting a sales price for the program.

In another particular embodiment a computer readable medium having a computer program for distributing video data from an originating device in a communication network is disclosed. The computer program includes instructions to store metadata at the originating device describing the video data, instructions to select at the originating device, a plurality of candidate devices to receive the video data based on a correlation between the metadata and subscriber profiles for the plurality of candidate devices, and instructions to distribute the video data to a first set of candidate devices selected from the candidate devices in the communication network based on the correlation.

In another particular embodiment the originating device, the plurality of candidate devices and a server are members of a peer to peer network in an internet protocol television (IPTV) network and the video data is made available to members of the peer to peer network for distribution over the peer to peer network.

In another particular embodiment of the medium the originating device sends video data to the server for distributing the video data to subscribers via the IPTV network.

In another particular embodiment of the medium distributing the video data further includes sending the video data in near real time from the originating device through a server to the first set of candidate devices. In another particular embodiment the computer program further includes instructions to search metadata at the originating device for a plurality of video data files to select desired video data files from the plurality of video data files having desired attributes based on a set of recommendation criteria, instructions to aggregate video data files having the desired attributes into a video program at the originating client device, and instructions to send the program from the originating device to another member of the peer to peer network.

In another particular embodiment of the medium the computer program further includes instructions to determine an advertising category for the program based on a correlation between the metadata and an advertising category and inserting an advertisement from the advertising category into the program. In another particular embodiment the computer program further includes instructions to place a listing for the video data in an electronic program guide based on a set of recommendation criteria. In another particular embodiment the computer program further includes instructions to recommend to a second set selected from the candidate devices video data video programs based on the set of recommendation criteria.

In another particular embodiment the recommendation criteria is selected from the group consisting of popularity, number of viewings, number of ratings, percent of viewings rating, percent of rating favorable, percent of ratings unfavorable, demographics for favorable ratings and demographics for unfavorable ratings.

In another particular embodiment of the medium the computer program further includes instructions to correlate recommendation criteria with an advertising type and placing an advertisement in the video program based on the correlation. In another particular embodiment of the medium the computer program further includes instructions to apply processing to the program selected from the group consisting of applying digital rights management, applying approved video formatting and setting a sales price for the program.

In another particular embodiment a system for distributing video data from an originating device in a communication network is disclosed. The system includes a server having a processor in communication with a memory; a computer program stored in the memory, the computer program including instructions to store metadata received from originating device describing the video data, instructions to select at the server, a multiplicity of candidate devices to receive video data based on a correlation between the metadata and subscriber profiles for the plurality of candidate devices; and instructions to distribute the video data to a first set selected from the plurality of candidate devices in the communication network based on the correlation.

In another particular embodiment the system the originating device, the plurality of candidate devices and the server are members of a peer to peer network in an internet protocol television (IPTV) network and wherein the video data is made available to members of the peer to peer network for distribution over the peer to peer network.

In another particular embodiment of the system the server receives the video data from the originating device for distribution of the video data to subscribers to the IPTV network. In another particular embodiment the system the video data is received from the originating device and distributed to the subscriber to the IPTV network in near real time. Near real time appears to be live as there is essentially only a network transmission delay between the originating device and a viewing device viewing the video data.

In another particular embodiment the computer program further includes instructions to search metadata at the server for video data files to select desired video data files from the video data files having desired attributes based on a set of recommendation criteria, aggregating at the server, video data files having the desired attributes into a video program at the originating client device, and sending the program from the originating device to another member of the peer to peer network.

In another particular embodiment of the system the computer program further includes instructions to determine at the server an advertising category for the program based on a correlation between the metadata and an advertising category and instructions to insert at the server, an advertisement from the advertising category into the program. In another particular embodiment of the system the computer program further includes instructions to place a listing for the video data in an electronic program guide at the server based on a set of recommendation criteria.

In another particular embodiment of the system the computer program further includes instructions to recommend at the server, to a second set selected from the plurality of candidate devices, video data video programs based on the set of recommendation criteria. In another particular embodiment the recommendation criteria is selected from the group consisting of popularity, number of viewings, number of ratings, percent of viewings rated, percent of ratings favorable, percent of ratings unfavorable, demographics for favorable ratings and demographics for unfavorable ratings.

In another particular embodiment of the system the computer program further includes instructions to correlate at the server, recommendation criteria with an advertising type and instructions to place an advertisement in the video program at the server based on the correlation.

In another particular embodiment of the system the computer program further includes instructions to apply processing at the server to the program selected from the group consisting of applying digital rights management, applying approved video formatting and setting a sales price for the program.

Major telecommunications companies are seeking to compete with cable companies as broadcast video providers by providing broadcast video services either via fiber to the home (FTTH) networks, which carry data signals to the home with fiber optic cable (running fiber optic cable from the IPTV network all the way to the residence), and fiber to the node (FTTN) networks (running fiber optic cable from the communication network, e.g., an IPTV network to a node in the IPTV network or a node in a communication network or delivery system associated with the IPTV network, existing copper telephone cable is run from the FTTN node to the residence), which extend fiber optic cable deeper into neighborhoods, getting the fiber close enough to homes to reduce any remaining copper phone line loop length short enough to provide sufficient bandwidth to send multiple video data television streams over the combination of fiber optic and copper lines. Such networks are capable of being configured as a “switched” video architecture, sending only one channel of video data over the Internet to each television or STB in the home.

The term Internet Protocol Television (IPTV) is used in this disclosure to describe delivery of digital video television signals over a communication network such as the Internet. Unlike broadcast networks, standard cable television and satellite television, which broadcast an array of channels and leave the “tuning” of the channel desired to the TV or STB, with IPTV switched video architectures the channel change occurs in the network. Thus a large library of video files can be stored in accessible storage, such as in an IPTV network server storage, super node storage or an associated database, with an IPTV or switched video architecture a television subscriber can watch what they want, when they want, and have access to a potentially unlimited amount of video data from which to choose. In an illustrative embodiment subscriber authored video content including but not limited to video data and audio data can be distributed to other network subscribers over an IPTV network. For purposes of this disclosure, the term subscriber authored video content includes but is not limited to, any video data including associated audio and graphic data generated, originated or placed on a communication network by a subscriber or peer device for viewing by other subscribers, peers or other viewers having access to the communication network.

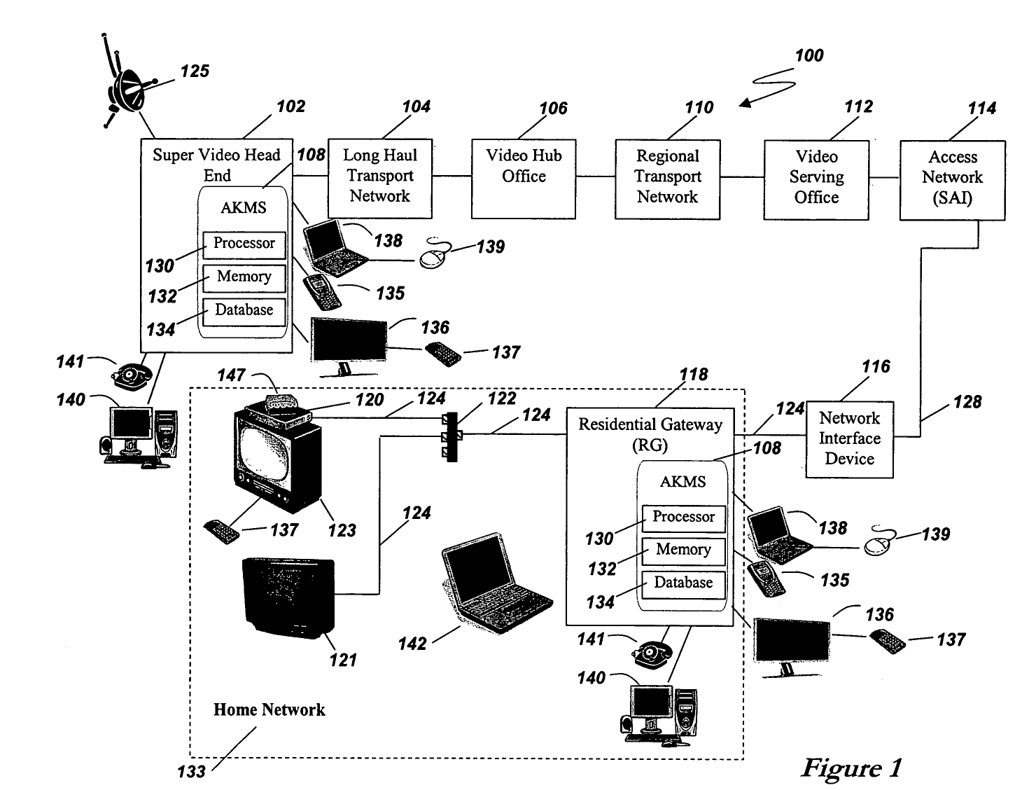

Turning now to FIG. 1, FIG. 1 is a block diagram of depicting an illustrative embodiment of a communication network, in this case, an IPTV network. The communication network depicted can include but is not limited to the architectural components of a high speed network capable of delivering data, voice, and particularly video data. For purposes of this disclosure, the term video data includes video data, metadata describing the video data and graphics data or audio data associated with the video data.

FIG. 1 depicts an illustrative embodiment used in conjunction with a general approach telecommunications companies are taking to deploy FTTN or FTTH based networks to deliver video data to network subscribers. It should be noted that while this embodiment shows three hierarchical levels of video serving offices, any number of hierarchical levels could be used.

The Super Video Head End (SVHE) 102 is a facility where standard broadcast (network) stations and other data can be received and prepared for transmission via Internet protocol (IP) over the IPTV network. Television stations, typically providing national network video source content (video data) can be received by the SVHE 102 via a telecommunications link directly from a broadcast station, or more commonly via satellite 125. The SVHE receives standard cable type broadcast channels via satellite 125 or other broadcast links, and encodes them into a standard format (e g., MPEG-4, H.264) for transmission over the Internet via some form of long haul network transport such as Gigabit Ethernet. A multi-state deployment of IPTV, for example, may utilize two SVHE's—one for redundancy. In an illustrative embodiment of a video distribution system and method disclosed herein, the SVHE may act as a central warehouse for subscriber created video data as well. In an illustrative embodiment, peer to peer network technology can be used to decentralize the uploading and rapid dissemination of the user authored video data. In the illustrative embodiment, the SVHE can act as any peer to peer client or super node or indexing node (like any other subscriber with a PC or set top box (STB)) to receive any video content television authored, originated or created by IPTV network subscriber author which was created and desired to made available for distribution to other IPTV network subscriber author who subscribes to the IPTV television service. The illustrative embodiment shows an IPTV system; however, a cable system could also be used for distribution of subscriber authored video content to cable television subscribers. Illustrative embodiments could be applied to any television distribution system. In an illustrative embodiment, the originating device and candidate devices can be for example an IPTV set top boxes and the server can be a head server in the IPTV network.

In the illustrative embodiment, several video hub offices (VHOs) 106 are 1 5 connected to each SVHE 102 via a long haul transport network 104. VHOs are commonly deployed in metropolitan areas. In addition to receiving the numerous television channels (typically national interest network video data, e.g., ESPN, CNN, ABC, NBC, etc.) via IP from the SVHE, the VHO can also be an insertion point for local channels and advertising (e.g., receiving local network channels via over the air antennas) and other local programming and content information.

Each central office (CO) of a telecommunications network (e.g., an IPTV system) (which provides standard telephone service and broadband services like Digital Subscriber Line (DSL)) can be configured to be a video serving office (VSO) 112. VSOs can also receive programming from the VHOs via some form of high speed IP network, such as Gigabit Ethernet. The VSOs in turn feed the video data to a local access network. In the case of fiber to the home (FTTH) deployments, the access network may consist of, but is not limited to, fiber extending from the VHO all the way to one or more STBs 120 at each customer's home network 133. In the case of fiber to the node (FTTN) deployments, fiber is typically run to a service access interface (SAI) 114 box via fiber, which in turn sends high speed video data to the home over existing telephone copper wiring 128. SAIs are placed as deep in the neighborhoods as feasibly possible so as to reduce copper phone line length between the SAI and the home sufficiently to minimize the transmission of high speed data over the existing copper lines, typically in excess of 25 megabits per second (Mbps). 25 Mbps bandwidth can be sufficient for providing several standard definition (SD) or high definition (HD) video data streams with proper compression.

Similar to the way telephone wiring is sometimes brought to a home by connecting it to a network interface device (NID) 116 on the side of the house, a NID capable of receiving a phone line with a high speed data signal (e.g., very high speed DSL (VDSL2)) can be installed on the side of the home. One of the purposes of the NID is to facilitate in-home delivery of a high speed video data signal. The high speed data signal may include, but is not limited to, video data and audio data. The standard telephone wiring in a residence can be used (as is the case with most DSL deployments) or alternatively wireless (e.g., wireless fidelity (WiFi), Ultra Wideband, etc.), broadband over power line (BPL) or coaxial cable (e.g. multi media over coax (MoCA), Home Phone Networking Alliance (HPNA)) could be used. FIG. 1 shows an illustrative embodiment of providing in-home distribution of voice, data, and video data signals via utilization of the existing coaxial wiring and wireless networks for cable television in the home.

The NID connects to a gateway (a home entrance port to a communication network, e.g., the IPTV communication network) such as a residential gateway (RG) 118 in or adjacent the home. The RG facilitates home networking via one or more implementations. Most RGs today support wireless home networking via the Institute of Electrical and Electronic Engineers (IEEE) WiFi standard, which lets users connect to the Internet wirelessly, for example, from a laptop computer. The illustrative home networking implementation shown in this figure not only supports wireless networking, but also uses the coaxial wiring to distribute video data packets (in particular video streams) to other devices in the home including televisions equipped with STBs 120, and even televisions 121 without STB.

Subscribers of IPTV may utilize one or more IP enabled STBs to receive and watch a television signal in the form of received video data and audio data displayed on a television receiver 123. The STB receives IP packets of video data representing television programming via Internet protocol over, for example, coaxial wiring using a technology such as HPNA or MoCA. The STB 120 decodes the packets into a television signal, which can be sent to a standard television 123 via HDMI or component jacks. An STB may be capable of decoding and sending and/or receiving more than one video stream. The home network depicted in FIG. 1 shows a second television 121 connected via standard coaxial cable, such as a standard analog television using analog based television might be connected. Such a television can receive a separate IP video stream using the home network by incorporating a remote control that uses radio frequency (RF) to avoid a need for line of sight communication between the remote control and television. In this manner, the remote control 137 for the second TV 121 is actually communicating with the STB on the other television 123, which is tuning to a different channel and then transmitting the channel in analog format to the other television 123 via the coaxial cable or wireless network in the home. The STB may also have a IEEE 1394 “firewire” or similar connection for connecting a digital camcorder to the IP STB, along with software running on the IP STB that permits the user to input the video data from the camcorder to a subscriber device such as a personal computer or STB, edit the video as desired, and “post it” (place or upload the video data on a memory accessible to viewing subscribers) for distribution to the other communication network television subscribers. This may or may not include payment requirements levied on viewing to view the subscriber authored video data, for which the author or originator of the video data and the network provider may share in the payment revenue.

As shown in FIG. 1, in an illustrative embodiment, an advertising knowledge management system (AKMS) 108 may be associated or contained in the super video head end 102, a residential gateway (RG) 118 or a STB 120. The AKMS is described fully in co-pending co-owned U.S. patent application Ser. No. 11/405,969 filed on Apr. 18, 2006, which is hereby herein incorporated by reference in its entirety. As shown in FIG. 1, the super video head end 102 (e.g., satellite ground station that receives channels via satellite and encodes for distribution over the IPTV network) relays a video and data signal to a long haul transport network 104 (e.g., Gigabit Ethernet). The processor that hosts or is associated with the AKMS also monitors subscriber event data inputs associated with the subscriber access devices. The subscriber event data is monitored by an AKMS 108.

Event data may be collected from subscriber communications as a subscriber uses a subscriber access device (or by inputting files created by a service provider based on subscriber verbal or text input), including creating a user profile, or various other activities discussed above, including but not limited to using a subscriber access device which may include but is not limited to a PSTN telephone 138, cell phone 134, personal computer 139, PDA, computer mouse 139, or IPTV receiver 136 and input device, such as a remote control 137, web tablet, lap top computer, pocket PC, and mobile IP device. The AKMS includes a processor 130 coupled to memory 132 and database 134 in memory. A computer readable medium containing instructions that can be executed by the processor is embedded in the memory. The AKMS keeps track of subscriber activity to update a profile on the subscriber to determine what video data is most popular and what video data may be appropriate to present to subscribers based on their user profile, as updated by the AKMS.

The long haul transport network 104 relays the video and audio data signal to the VHO 106 (e.g., a metro office that receives video data from a super video head end (VHE) and inserts local channels for viewing in the metro area receiving video data from the VHO).

The VHO 106 relays the signal to the regional transport network 110 (e.g., Gigabit Ethernet). The regional transport network 110 relays the signal to the video serving office 112 (e.g., Telco Central Office delivering voice, data, and video to neighborhoods via Gigabit Ethernet links). The video serving office 112 relays the signal to the access network 114 (e.g., FTTH, FTTN network with VDSL delivery to the home). The access network 114 relays the signal via a fiber optic link (if fiber to the home (FTTH) is used to carry the video data) or telephone wiring (if fiber to the node (FTTN) is used to carry the video and data) 128 to the network interface device (NID) 116. The NID 116 relays the signal via the coaxial cable 124 to a gateway such as a residential gateway (RG) 118.

The AKMS includes a processor 130 coupled to memory 132 and database 134 in memory. A computer readable medium containing instructions that can be executed by the AKMS processor is embedded in the memory. The signal is relayed from the RG 118 via the coaxial cable 124 to the coaxial splitter 122, which splits the signal via coaxial cables 124 to an STB 120, and other television sets on the home network. The signal can also be sent to laptop computers 126. The above example is for illustration only and can be implemented in numerous different ways in a variety of different type communication systems, such as in an IPTV system.

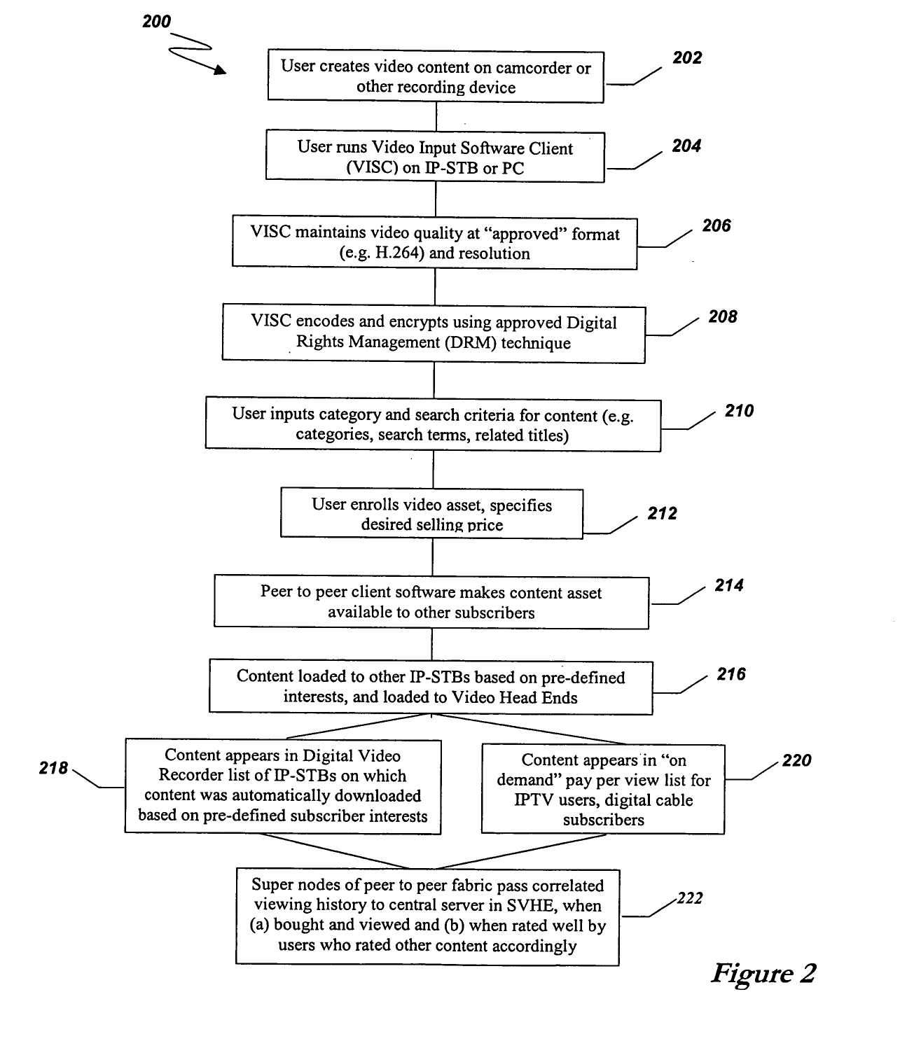

Turning now to FIG. 2, FIG. 2 shows functions performed by a subscriber author using a video input software client (VISC) 147 (as shown in FIG. 1), running on a processor such as an STB or standard personal computer on the home network, and the supporting video distribution system, in making user authored content available on the television network for optional purchase, and viewing, by other television service subscribers. The subscriber may create video content using a video camcorder or similar video recording device at 202. The subscriber may also post or distribute video which he or she did not create, but wants to make available for distribution to other subscribers over the communication network. Alternatively, the user/subscriber may input video data to a personal computer and using a video authoring system, e.g., Adobe® Premiere® or Pinnacle® Studio® to compose and author the final video data content. The subscriber can then run the VISC application 147 on either a television STB, personal computer, or other Internet connected display device at 204.

In another illustrative embodiment the VISC examines subscriber authored video data and includes but is not limited to a built-in quality assurance mechanism to enforce the video data quality, i.e., the resolution and the way the video data is encoded (e.g., using H.264 encoding/decoding (codecs), motion picture expert group (MPEG-4), etc.) to help maintain a consistent level of quality of all content available within the video pay-per-view archives at 206. The VISC checks the video data for predetermined allowable formatting (H.264, MPEG-4, etc.), viruses and adds digital rights management (DRM) and metadata describing the video data. The VISC 147 thus helps avoid problems that may be experienced when users can post or distribute or upload varying quality video data of just about any type of video data content even if the content contains errors in format, viruses, low resolution unacceptable for display or a home television set, (e.g., H.264, MDE6-4, etc.) etc. Next, the VISC uses an approved video data format to encode the content at the appropriate resolution and media format, also incorporating a consistent Digital Rights Management (DRM) system that encrypts the video data so it can only be unlocked and viewed by authorized viewing subscribers who have obtained a digital rights “key” from the subscriber author (or subscriber originator) or a video service provider at 208.

In order to facilitate search and retrieval of subscriber authored video data content by other television service subscribers, the author includes pertinent metadata including categories under which the video data content may fall (e.g., author name, length, resolution, action, documentary, music, sports, demographic interest, gaming, language, etc.), key word search terms (e.g., locomotives, toys), duration, MPAA rating, duration, date of creation and related video data content titles (e.g., other videos on the system the author thinks are related to her newly created video content) at 210. The author can also be used as a search criteria by other subscribers, for example, if a viewing subscriber views one video by a particular video author they may set up their own pre-defined “interest” profile to include any other videos authored, originated or distributed by the subscriber author—this would cause new videos by the video author to be automatically downloaded to the viewing subscriber's DVR, for example, from the VHE or some other video data repository associated with the IPTV network on the subscriber author's STB.

Next, the author “enrolls” the video data asset at 212, setting a selling price and releasing it for distribution via the peer to peer distribution (or similar) network. The video author can set a price for a subscriber viewing the video data and for a subscriber obtaining digital rights to view the video author's video data (e.g. once, 24 hours, in perpetuity). The peer to peer client makes the video data asset available on the communication network (which can be any digital communication network, but in the illustrative embodiment, an IPTV network) for upload by any other devices on the network participating in the peer to peer video distribution network, including other subscribers STBs, VHEs, etc. at 214.

Other viewing subscribers can receive the video author content in numerous different ways. For example, television subscribers set up their own “interest” profile, defining categories, topics, content authors, etc. in which they are interested. The AKMS in the IPTV network or video distribution system keeps track of historical ordering/viewing/recording data of which movies or video data different subscribers have ordered, recorded or watched, and correlates that historical ordering/recording/viewing data to all of their other viewing habits. Users can also “rate” video content they have watched to further correlate interests in various video titles, so recommendations can accordingly be made to other viewing subscribers based on a subscriber's ratings of the video data. Thus, a particular subscriber authored video data can be rated as to popularity as a combination of the number of viewings and favorable and unfavorable ratings. These ratings can be stored and updated at the subscriber author's memory as part of the metadata for the video data. It might be the case that millions of viewers are viewing a particular subscriber authored video data and 90% of the ratings are unfavorable. Thus, the subscriber authored video data for recommending the subscriber authored video data to others based on number of viewings alone could be a misleading metric. To offer or recommend subscriber authored video data, in an illustrative embodiment, the AKMS and/or the VISC collects the ratings data for the video data and considers the number of viewings and the number of favorable and unfavorable ratings along with the demographic category of the viewers who have viewed the subscriber authored video data and rated it favorably. It might be that male's age 18-25 rate a subscriber authored video data favorably and females age 18-25 rate it unfavorably. Thus, in an illustrative embodiment, the AKMS and/or VISC would recommend or present the subscriber authored video data to males age 18-25 but not females age 18-25 based on the gender bias of the ratings for the video data.

Subscriber video data substantially matching or correlating with the “interest” profiles of other video service viewing subscribers can be automatically downloaded to the other viewing subscribers respective STBs memory or DVRs by a peer to peer client or VISC 147 running on the STB at 216. The VHE also acts as a peer as an interested client of popular subscriber generated content, so as to cache the video data content for future peer to peer distribution, and to make it available for “switched” multicast delivery to subscribers that either proactively search for on demand content, don't have a DVR incorporated into their STB, or perhaps are receiving television on a digital cable network that allocates part of its coaxial spectrum range to deliver the video as an “on demand” channel to the subscriber.

For those subscribers whose predefined “interests” profiles caused a match and subsequent download of the subscriber authored video data to their STB, the video content appears as a “recorded” item in their recorded programs list on their digital video recorder at 218. For users of an “on demand” video delivery system such as video that can be received “switched” from an Internet television architecture or on-demand or switched from a digital cable network, the video content appears in the “on demand” VHE content list at 220.

In either event, client devices running the peer to peer applications that end up becoming “super nodes” or indexing nodes in the peer to peer network help correlate viewing histories of other peers or client nodes (i.e., STBs, PCs, etc.) and send the viewing history data up to a central server memory or data base associated with the SVHE facilities at 222. This helps the video distribution system make educated recommendations to viewing subscribers based on what other viewing subscribers have watched and/or rated, to help make the process of automatically downloading potential video data content files of interest to viewing subscribers' STBs at 216.

It should be noted that television viewers also can search for video data content. The SVHE video data content storage server could be indexed via (a) publisher defined keywords and/or (b) speech-to-text conversion of the audio stream or capturing the close captioning information (if available).

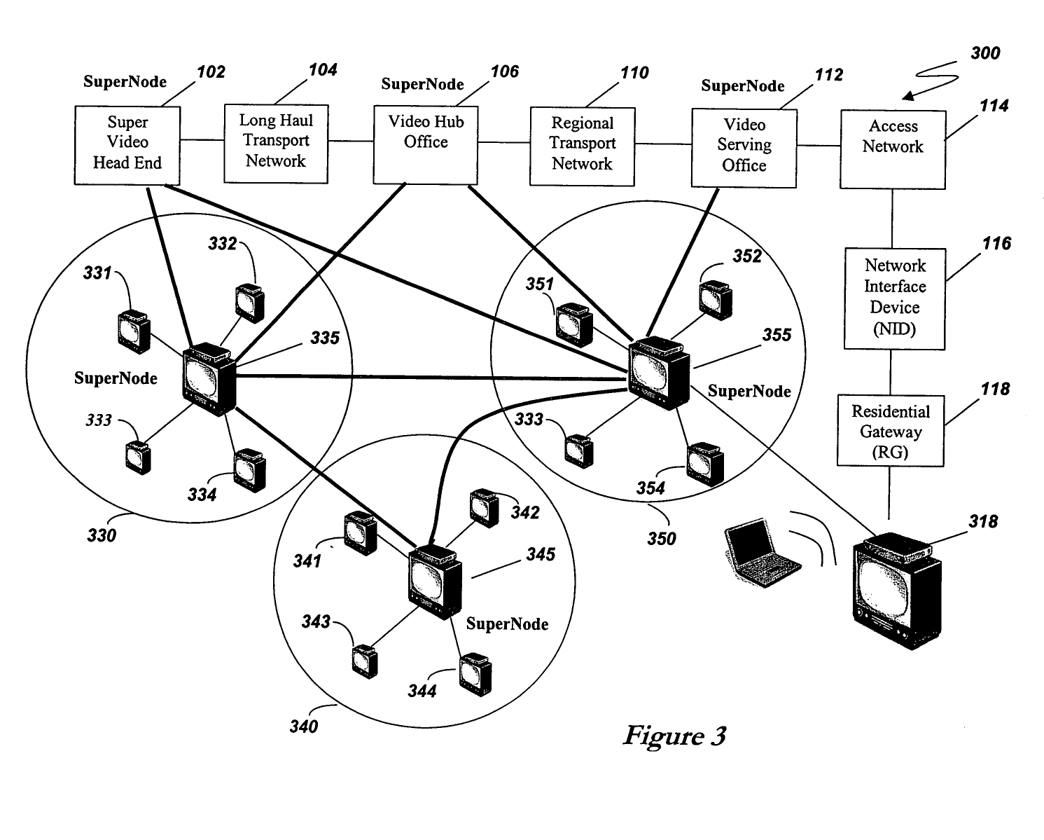

Turning now to FIG. 3, FIG. 3 is a schematic diagram of an illustrative embodiment including peer groups (peer to peer networks) for video data distribution in an IPTV system. The community if IPTV subscribers all participate in video distribution by acting as nodes in a peer to peer network. Typical of today's peer to peer networks which provide a totally decentralized (non server based) architecture by nominating certain nodes to be “super nodes” that keep indexes of content, video data and the associated metadata available from a subset of other nodes, certain IPTV set top boxes are designated as super nodes. In addition, the various head ends or other nodes or servers in the IPTV network can also be designated as super nodes. This provides a very scalable architecture as more and more IPTV subscribers are added to the system, with no associated server infrastructure required. A piece of video content or video data would typically be replicated from one IPTV box to many others by sending pieces of the video to different set tops initially. In this manner, other IPTV set tops requesting the content now have multiple sources with which to obtain various pieces of the video content or video data, rather than the STB of the subscriber that originally posted the content. Super Video Head End 102 sends a signal to Long Haul Transport Network 104 and super nodes 335 and 355. The Long Haul Transport Network 104 sends a signal to the VHO 106 which in turns sends the signal to super nodes 335 and 355 and regional transport network (RTN) 110. The RTN 110 sends the signal to the Video Serving Office 112. The Video Serving Office 112 sends the signal to the super node 355 and the Access Network 114. The Access Network 114 sends the signal to the Network Interface Device (NID) 116. The Network Interface Device (NID) 116 sends the signal to the RG 118. The RG 118 sends the signal to the IPTV STB 318 and standard Personal Computer both supporting the VISC.

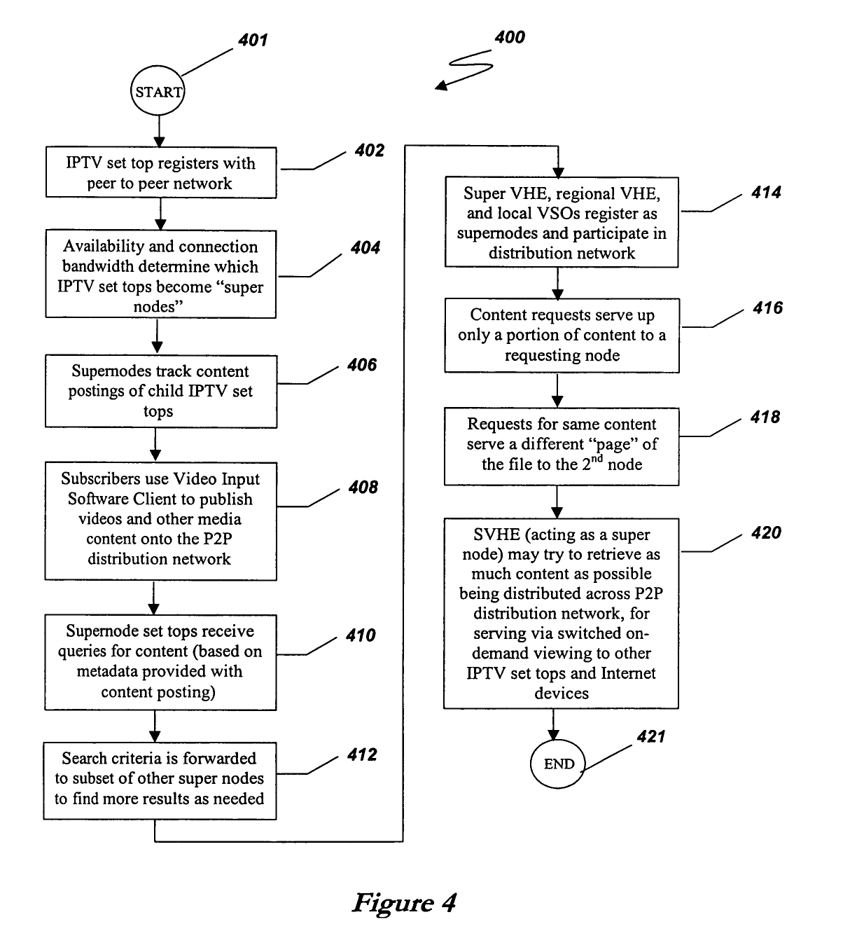

Turning now to FIG. 4, FIG. 4 illustrates the use of peer to peer technology to efficiently and rapidly disseminate the video content to other users, either directly (based on predefined interests as stipulated by the television subscriber) or indirectly by performing a search in memory of video data metadata including but not limited to subject, popularity, demographics, author, category, ratings data, number of viewings, number of favorable ratings, number of unfavorable ratings and demographic data for viewers and rating viewers, etc. The IPTV STBs register with the peer to peer network at 402. The availability and connection bandwidth determines which IPTV STB becomes “super nodes” at 404. Super nodes track content postings metadata and ratings data of child (STBs associated with a super node STB) IPTV STBs at 406. Child STBs report video data postings publishings, uploads or video data available notifications to the super nodes. Subscriber authors use the VISC 147 to publish video data, metadata for the video data and other media data content onto the peer to peer distribution network at 408. Super nodes (VHE or STBs) receive queries for video data content (based on metadata provided with video author subscriber content posting) at 410. Search criteria are forwarded to subsets of other super nodes to search for additional results as desired at 412. Super VHE, regional VHE and local VSOs register as super nodes and participate in distribution network at 414. Content requests serve up only a portion of video data content file to a requesting node at 416. Requests for same content serve a different “page” of the video data file to the 2nd node at 418.

SVHE (acting as a super node) may retrieve as much video data content as possible as it is being distributed across the peer to peer distribution network, for serving via switched on demand viewing to other STBs and Internet devices at 420.

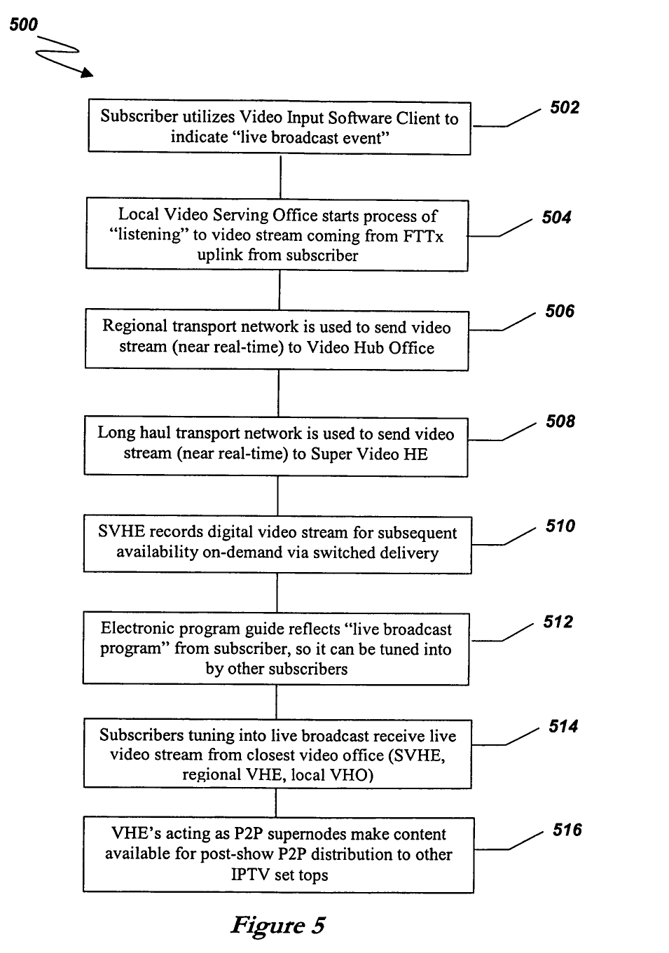

Turning now to FIG. 5, FIG. 5 illustrates methods for providing an additional service based on the same video authoring and distribution architecture to provide “live” or near real time subscriber authored video data content, providing live or near real time access to subscriber authored video data. Subscribers utilize the VISC 147 to post or indicate a “live broadcast event” at 502. A local Video Serving Office starts process of“listening” to video streams coming from FTTN or FTTH uplink from “a live” subscriber authored video data at 504. A regional transport network can be used to send the subscriber authored video data stream (in near real-time) to a VHO at 506. The long haul transport network is used to send a video data stream (new real-time) to SHVE at 508. The SVHE records digital video stream for subsequent availability via “on demand” distribution to other video viewing subscribers via switched delivery over the communication network at 510. In an illustrative embodiment, an electronic program guide (EPG) provided by the VHE or by an STB, reflects “live broadcast program” from the subscriber author, so it can be tuned and watched by other subscribers at 512. Thus, there can be multiple EPGs provided, those provided to all subscribers from the communications network (e.g., VHE) and those EPGs provided by subscriber authors for the video data programs offered by the subscriber author. Subscribers tuning into live broadcasts can receive live (near real time) video streams from closest video office (SVHE, regional VHE, and local VHO) at 514. Receipt of these video streams can be accomplished at an STB via unicast, or by joining a multicast stream of the live event already being viewed by other subscribers. VHEs acting as peer to peer super nodes can make subscriber authored video data available for post-show peer to peer distribution to other IPTV STBs at 516.

In addition to publishing a video data file for sale, a subscriber author can provide a round-the-clock or scheduled (e.g., weekdays from 8-10 PM) program and their own EPG or reflect their video data offering in an EPG that is offered by the VHE on the IPTV network. In either case the subscriber authored video data can be sent in near real time from the VHE or from another intermediate server in the IPTV network or distributed as a peer to peer distributed video data file. The peer to peer distribution technique may include but is not limited to Bit Torrent®.

In providing the subscriber authored video data to the communication network (e.g., IPTV network) for near real time distribution, the upstream bandwidth of a high speed FTTN or FTTH platform, and always on connection, in effect provides the opportunity to make every television subscriber their own broadcaster. Subscribers search for content using the same techniques described above. Subscriber may search a super node or VHE memory containing subscriber authored video data metadata to find video data in a particular category, type, or in a particular demographic appeal. For example, a subscriber viewer may ask to see all video data by a certain author, in a certain category (sports, musical genre (rap, gospel, rock, etc.)) or in a certain demographic category (most popular for girls 18-35). The subscriber author or video data distribution provider has the option of letting subscriber viewers see the video data when it is broadcast originally by the subscriber author (i.e., “live” or near real time) only, or any time via switched video. Viewer subscribers can click a button on their remote control to denote a “video bookmark” in the video data or program, regardless of whether the video data is being present near real time/live, switched on demand, or being stored on the viewing subscriber's DVR. Whether live or switched, the bookmark is preserved separately from the video data content for efficiency. The book mark denotes a particular position in the video data so that once the video data is stored the position in the video data indicated by the book mark can be located on demand.

It should be noted that while the illustrative embodiment of this video data distribution architecture utilizes a FTTN or FTTH broadband network for IPTV delivery, video data distribution could similarly be implemented to work on alternative access networks including digital cable networks, terrestrial wireless delivery networks (e.g., WiMAX) as bandwidth improves, or even 3G and 4G wireless networks using wireless handsets as the video authoring station, that also have the peer to peer distribution client software (VISC) enabled on the handset.

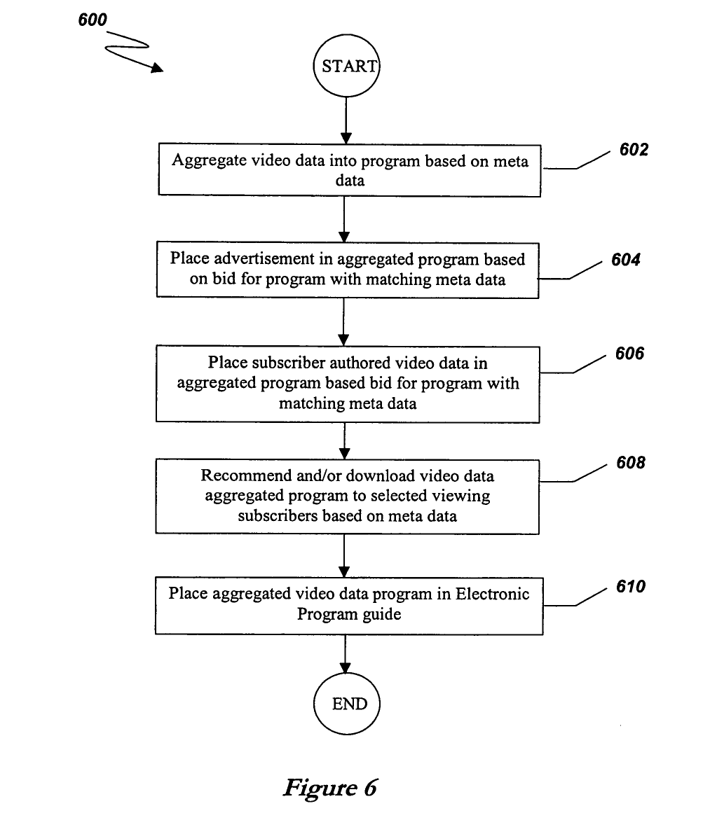

Turning now to FIG. 6, an illustrative embodiment of functions performed in aggregating subscriber authored video data into subscriber authored aggregate data programs is depicted in flow chart format. Similar subscriber authored video data based on type (sports, music, news, demographic appeal, ratings, popularity, etc.) can be aggregated into a video program for presentation to a multiplicity of subscriber viewers deemed receptive to the program based on popularity and ratings within demographic categories of the video data from which the program was formed.

Video data is aggregated into program based on metadata at 602. The advertisement is placed in aggregated program based on bid for program with matching metadata at 604. Subscriber authored video data is placed in aggregated program based bid for program with matching metadata 606. Video data aggregated program is recommended and/or downloaded in to selected viewing subscribers based on metadata at 608. The aggregated video data program is placed in Electronic Program guide at 610. In a particular illustrative embodiment, advertisers can bid on placing advertisements in the aggregate data program of subscriber authored video data based on meta data including but not limited to popularity, demographic appeal, category or type (sports, music, news, ratings data, demographic appeal, popularity, etc.). In another particular embodiment advertisers can bid on placing advertisements in subscriber authored aggregate programs. In another particular embodiment, subscriber authors can bid on having their subscriber authored video content being placed in a subscriber authored aggregate program.

In the case of advertisers bidding on subscriber authored video content, bids can be placed by advertisers based on various factors, including but not limited to popularity, geographic and demographic appeal, etc. In the case of subscriber authors bidding on having their subscriber authored video data being placed in a program of subscriber authored aggregate video data, subscriber author bids can be placed by video based on various factors, including but not limited to popularity, ratings data, geographic location of viewers and demographic appeal, etc. Bids by advertisers or subscriber authors can be placed based on popularity and ratings data within a given targeted demographic category (males 18-25) and in a give time slot when it is determined that a targeted demographic is most active. The bid can also be set for a given level of actual or predicted activity on the communication network for a targeted demographic without regard to time, such as, whenever 1,000 or more males 18-25 are accessing the communication system and are available for viewing the program in near real time or live. The advertisement placed in the aggregate data program can also change over time; for example, a new high bidder may come in two weeks after the program was posted and replace the advertisement that was previously provided with the content. For “on demand” viewings arriving via switched programming for the head end, the advertisement is dynamically replaced. For downloaded files obtained via the peer to peer network, a new advertisement could similarly be downloaded to each IPTV set top housing the content, replacing the old advertisement.

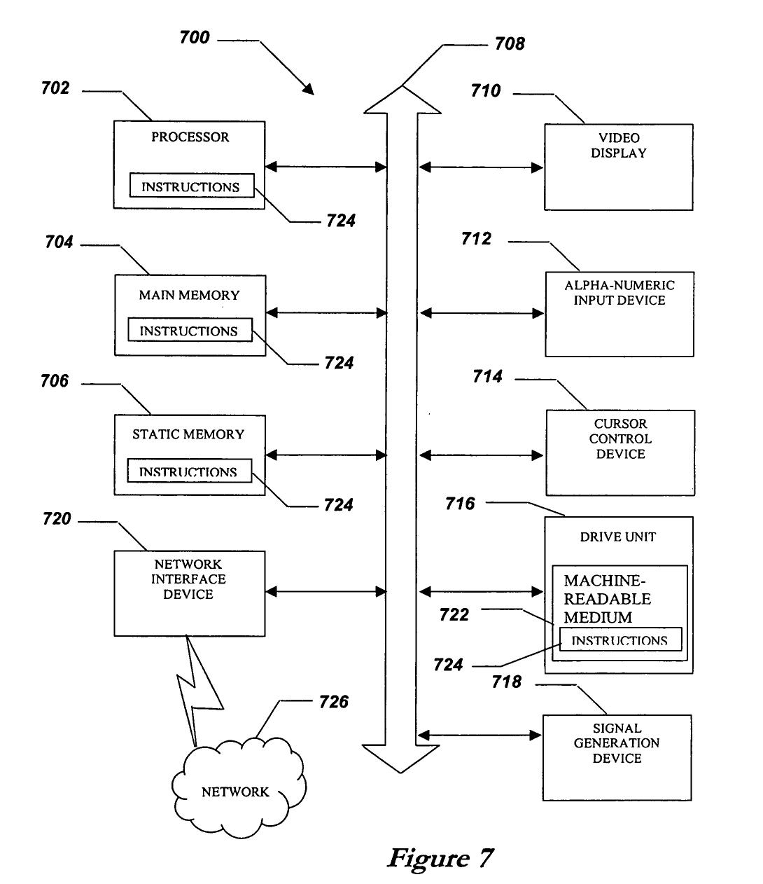

Turning now to FIG. 7 the computer system 700 may include a processor 702 (e.g., a central processing unit (CPU), a graphics processing unit (GPU), or both), a main memory 704 and a static memory 706, which communicate with each other via a bus 708. The computer system 700 may further include a video display unit 710 (e.g., liquid crystals display (LCD), a flat panel, a solid state display, or a cathode ray tube (CRT)). The computer system 700 may include an input device 712 (e.g., a keyboard), a cursor control device 714 (e.g., a mouse), a disk drive unit 716, a signal generation device 718 (e.g., a speaker or remote control) and a network interface device 720.

The disk drive unit 716 may include a machine-readable medium 722 on which is stored one or more sets of instructions (e.g., software 724) embodying any one or more of the methodologies or functions described herein, including those methods illustrated in herein above. The instructions 724 may also reside, completely or at least partially, within the main memory 704, the static memory 706, and/or within the processor 702 during execution thereof by the computer system 700. The main memory 704 and the processor 702 also may constitute machine-readable media. Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the illustrative embodiment, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The illustrative embodiment contemplates a machine readable medium containing instructions 724, or that which receives and executes instructions 724 from a propagated signal so that a device connected to a network environment 726 can send or receive voice, video or data, and to communicate over the network 726 using the instructions 724. The instructions 724 may further be transmitted or received over a network 726 via the network interface device 720.

While the machine-readable medium 722 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the illustrative embodiment. The term “machine-readable medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and carrier wave signals such as a signal embodying computer instructions in a transmission medium; and/or a digital file attachment to e-mail or other self-contained information archive or set of archives is considered a distribution medium equivalent to a tangible storage medium. Accordingly, the illustrative embodiment is considered to include any one or more of a machine-readable medium or a distribution medium, as listed herein and including art-recognized equivalents and successor media, in which the software implementations herein are stored.

Although the present specification describes components and functions implemented in the embodiments with reference to particular standards and protocols, the illustrative embodiment is not limited to such standards and protocols. Each of the standards for Internet and other packet switched network transmission (e.g., TCP/IP, UDP/IP, HTML, and HTTP) represent examples of the state of the art. Such standards are periodically superseded by faster or more efficient equivalents having essentially the same functions. Accordingly, replacement standards and protocols having the same functions are considered equivalents.

What is claimed is:

1. A method for distributing video data from an originating device in a communication network, the method comprising:
storing metadata for the video data at the originating device;
selecting at the originating device, a plurality of candidate devices to receive the video data based on a correlation between the metadata and subscriber profiles for the plurality of candidate devices; and
distributing the video data to a first set of candidate devices selected from the plurality of candidate devices in the communication network based on the correlation.

2. The method of claim 1, wherein the originating device, the plurality of candidate devices and a server are members of a peer to peer network in an internet protocol television (IPTV) network and wherein the video data is made available to members of the peer to peer network for distribution over the peer to peer network.

3. The method of claim 2, wherein the originating device sends the video data to the server for distributing the video data to subscribers to the IPTV network.

4. The method of claim 1, wherein distributing the video data further comprises sending the video data in near real time from the originating device through a server to the first set of candidate devices.

5. The method of claim 4, wherein distributing the video data further comprises sending a multicast stream from the originating device which the first set of candidate devices can join.

6. The method of claim 3, further comprising:
searching metadata at the originating device for a plurality of video data files to select desired video data files from the plurality of video data files having desired attributes based on a set of recommendation criteria;
aggregating video data files having the desired attributes into a video program at the originating client device; and
sending the program from the originating device to another member of the peer to peer network.

7. The method of claim 6, further comprising:
determining an advertising category for the program based on a correlation between the metadata and an advertising category; and
inserting an advertisement from the advertising category into the program.

8. The method of claim 7, further comprising:
placing a listing for the video data in an electronic program guide based on a set of recommendation criteria.

9. The method of claim 8, further comprising:
recommending to a second set of candidate devices selected from the plurality of candidate devices, video data video programs based on the set of recommendation criteria.

10. The method of claim 9, wherein the recommendation criteria is selected from the group consisting of popularity, number of viewings, number of ratings, percent of viewings rating, percent of rating favorable, percent of ratings unfavorable, demographics for favorable ratings and demographics for unfavorable ratings.

11. The method of claim 6, further comprising:
correlating the recommendation criteria with an advertising type; and
placing an advertisement in the video program based on the correlation.

12. The method of claim 6, further comprising:
applying processing to the program, the processing selected from the group consisting of applying digital rights management to the program, applying approved video formatting to the program and setting a sales price for the program.

13. A computer readable medium having a computer program for distributing video data from an originating device in a communication network, the computer program comprising:
instructions to store metadata at the originating device describing the video data;
instructions to select at the originating device, a plurality of candidate devices to receive the video data based on a correlation between the metadata and subscriber profiles for the plurality of candidate devices; and
instructions to distribute the video data to a first set selected from the plurality of candidate devices in the communication network based on the correlation.

14. The medium of claim 13, wherein the originating device, the plurality of candidate devices and a server are members of a peer to peer network in an internet protocol television (IPTV) network and wherein the video data is made available to members of the peer to peer network for distribution over the peer to peer network.

15. The medium of claim 14, wherein the originating device sends the video data to the server for distributing the video data to subscribers to the IPTV network.

16. The medium of claim 13, wherein distributing the video data further comprises sending the video data in near real time from the originating device through a server to the first set of candidate devices.

17. The medium of claim 15, the computer program further comprising instructions to search metadata at the originating device for a plurality of video data files to select desired video data files from the plurality of video data files having desired attributes based on a set of recommendation criteria;
instructions to aggregate video data files having the desired attributes into a video program at the originating client device; and
instructions to send the program from the originating device to another member of the peer to peer network.

18. The medium of claim 17, the computer program further comprising:
instructions to determine an advertising category for the program based on a correlation between the metadata and an advertising category; and
inserting an advertisement from the advertising category into the video program.

19. The medium of claim 18, the computer program further comprising:
instructions to place a listing for the video program in an electronic program guide based on a set of recommendation criteria.

20. The medium of claim 19, the computer program further comprising:
instructions to recommend to a second set of candidate devices selected from the plurality of candidate devices video data video programs based on the set of recommendation criteria.

21. The medium of claim 20, wherein the recommendation criteria is selected from the group consisting of popularity, number of viewings, number of ratings, per cent of viewings rating, per cent of rating favorable, per cent of ratings unfavorable, demographics for favorable ratings and demographics for unfavorable ratings.

22. The medium of claim 17, the computer program further comprising:
instructions to correlate recommendation criteria with an advertising type; and
placing an advertisement in the video program based on the correlation.

23. The medium of claim 17, the computer program further comprising:
instructions to apply processing to the video program selected from the group consisting of applying digital rights management to the video program, applying approved video formatting to the video program and setting a sales price for the video program.

24. A system for distributing video data from an originating device in a communication network, comprising:
a server having a processor in communication with a memory; and
a computer program stored in the memory, the computer program comprising instructions to store metadata received from originating device describing the video data, instructions to select at the server, a plurality of candidate devices to receive video data based on a correlation between the metadata and subscriber profiles for the plurality of candidate devices and instructions to distribute the video data to a first set selected from the plurality of candidate devices in the communication network based on the correlation.

25. The system of claim 24, wherein the originating device, the plurality of candidate devices and the server are members of a peer to peer network in an internet protocol television (IPTV) network and wherein the video data is made available to members of the peer to peer network for distribution over the peer to peer network.

26. The system of claim 25, wherein the server receives the video data from the originating device for distribution of the video data to subscribers to the IPTV network.

27. The system of claim 26, wherein the video data is receive from the originating device and distributed to the subscriber to the IPTV network in near real time.

28. The system of claim 26, the computer program further comprising:
instructions to search metadata at the server for a plurality of video data files to select desired video data files from the plurality of video data files having desired attributes based on a set of recommendation criteria;
aggregating at the server, video data files having the desired attributes, into a video program at the server; and
sending the program from the server to another member of the peer to peer network.

29. The system of claim 28, the computer program further comprising:
instructions to determine at the server an advertising category for the program based on a correlation between the metadata and an advertising category; and
instructions to insert at the server, an advertisement from the advertising category into the program.

30. The system of claim 29, the computer program further comprising:
instructions to place a listing for the program in an electronic program guide at the server based on a set of recommendation criteria.

31. The system of claim 30, the computer program further comprising:
instructions to recommend at the server, to a second set selected from the plurality of candidate devices video data video programs based on the set of recommendation criteria.

32. The system of claim 31, wherein the recommendation criteria is selected from the group consisting of popularity, number of viewings, number of ratings, percent of viewings rating, percent of rating favorable, percent of ratings unfavorable, demographics for favorable ratings and demographics for unfavorable ratings.

33. The system of claim 28, the computer program further comprising:
instructions to correlate at the server, recommendation criteria with an advertising type and instructions to place an advertisement in the video program at the server based on the correlation.

34. The system of claim 28, the computer program further comprising:
instructions to apply processing at the server to the program selected from the group consisting of applying digital rights management to the program, applying approved video formatting to the program and setting a sales price for the program.
